(19) United States
(12) Patent Application Publication
(10) Pub. No.: US 2009/0044675 A1
(43) Pub. Date: Feb. 19, 2009

(54) Cutting arrangement having a tip-to-tip blade arrangement

(76) Inventor: Rudolf Supe-Dienes, Overath (DE)

Correspondence Address: ROBERT W. BECKER & ASSOCIATES, 707 HIGHWAY 333, SUITE B, TIJERAS, NM, 87059-7507, US

(21) Appl. No.: 11/841,252

(22) Filed: Aug. 20, 2007

(30) Foreign Application Priority Data
Aug. 19, 2007 (DE) 20 2006 012 820.4

(51) Int. Cl. B26D 1/25; B26D 7/01

(52) U.S. Cl. 83/500; 83/438

(57) ABSTRACT

A cutting arrangement for longitudinally cutting or dividing material comprising two blades that are disposed across from one another and that during the cutting process cooperate with one another. Each of the blades is embodied as a circular blade having a sharp cutting edge and supported by an adjusting or placement mechanism. During the cutting process the circular blades are positioned by the adjusting or placement mechanisms in such a way that the cutting edges overlap one another to form an overlap zone, the center of which coincides with the middle of the material that is to be cut or divided.

The present invention relates to a cutting arrangement for the longitudinal cutting or division of material and includes two blades that are disposed across from one another and that during the cutting process cooperate with one another.

If material having a great thickness, or in particular a stack of a plurality of superimposed lengths of material, which similarly have a corresponding overall material thickness, is to be cut or divided by a cuffing arrangement in a cut, there results, with a cutting arrangement that is comprised, for example, of an upper blade embodied as a circular blade and a lower blade embodied as a grooved counter blade, the problem that the cutting blade must penetrate appropriately deeply into the material that is to be cut, so that the outwardly disposed area of material is cut or pressed apart when the blade passes through not by the cutting edge, but rather by the blade face that is adjacent to the edge. In this area, a correspondingly poor cut quality is regularly registered.

It is therefore an object of the present invention to provide a cutting arrangement having the aforementioned general features with which it is also possible to cut or divide great material thicknesses of a material that is to be cut or divided with a defined cut quality.

The realization of this object, including advantageous embodiments and further developments of the invention, results from the content of the patent claims that follow this description.

The basic concept of the invention is a cutting arrangement where each of the blades is embodied as a circular blade that has a to sharp cutting edge and is supported by an adjusting or placement device, wherein during the cutting process the circular blades are positioned by means of the adjusting or placement mechanisms in such a way that the cutting edges overlap one another to form an overlap zone and the center of the overlap zone coincides with the middle of the material that is to be cut or divided. The invention has the advantage that two circular blades in a tip-to-tip arrangement are used as upper blade and lower blade, with the blades thus uniformly cutting into the material that is to be cut or divided from both sides. Since the two circular blades overlap to form an overlap zone, a complete severing of the material is ensured. To the extent that with such a blade arrangement the ideal cutting point is disposed in the middle of the overlap zone, by means of the positioning of the two circular blades the present invention sees to it that the middle of its overlap zone coincides with the middle of the material that is to be cut or divided.

Pursuant to one embodiment of the invention, the material is composed of a length of material having a corresponding material thickness, and the circular blades are positioned in such a way that the center of their overlap zone is disposed in the middle of the material thickness of the length of material.

Pursuant to another embodiment of the invention, the material to that is to be cut or divided is composed of a stack of individual lengths of material, and the circular blades are positioned in such a way that the center of their overlap zone is disposed in the middle of the overall material thickness of the stack of lengths of material.

To be able to undertake a precise positioning of the two circular blades that cut into the material, respective sensors for detecting the overlap zone can be disposed on the adjustment or placement mechanisms for the circular blades and can be coupled with control devices for the respective adjustment movement of the circular blades.

To the extent that on the one hand a fixation of the material that is to be fed must be effected, and on the other hand also a reference line for the setting of the position in particular of the lower blade of the blade arrangement must be present, it is proposed pursuant to an embodiment of the invention that the cutting arrangement include a fixation device for the feeding of the material that is to be cut or divided to the cutting blades, and that the lower blade extend beyond the upper edge of the fixation device by the amount that is to be set in conformity to the thickness of the material that is to be cut or divided and to the overlap zone of the cutting blades. In this connection, pursuant to specific embodiments of the invention, the fixation device can be embodied as a fixation or guide table that supports the material that is to be cut or divided, or also as an upstream fixation roller over which to the material that is to be cut or divided is guided.

The control devices for the adjustment movements of the circular blades can be connected to an input unit for the thickness of the material that is to be cut or divided; alternatively, a device for detecting or determining the thickness of the material that is to be cut or divided can be disposed upstream of the circular blades and can be connected with the control devices for the adjustment movements of the circular blades. In this connection, the device for determining or detecting the thickness of material that is to be cut or divided is expediently disposed on the fixation device for the feeding of the material that is to be cut or divided.

The drawing shows specific embodiments of the invention, which will be described subsequently, and in which drawings;

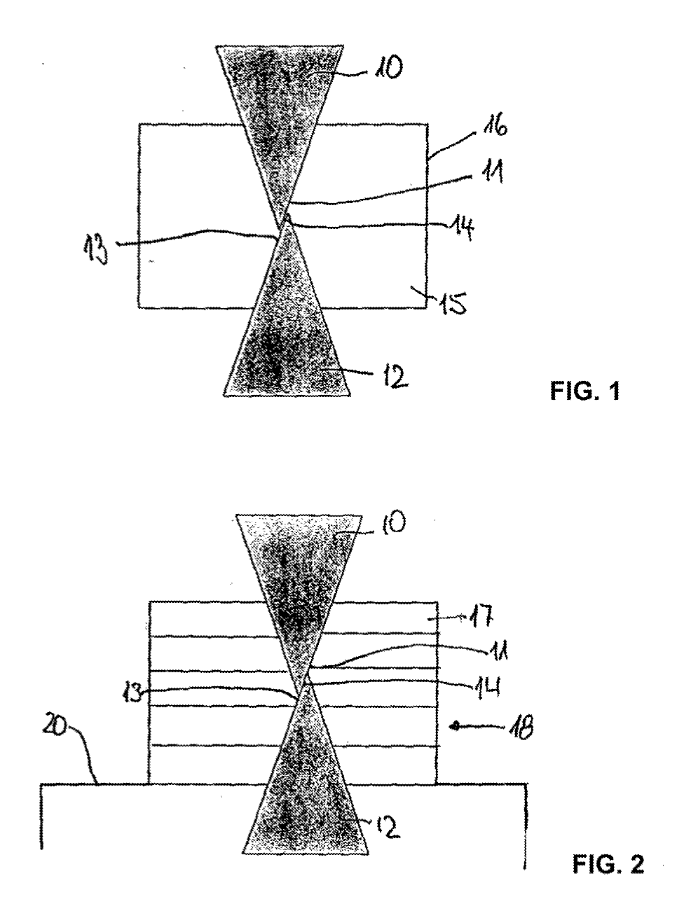

FIG. 1. is a schematic illustration showing a cutting arrangement, comprised of two cutting edges, or the cutting or dividing of a length of material,

FIG. 2 shows the subject matter of FIG. 1 for the cutting or dividing of a stack comprised of a plurality of super imposed lengths of material.

As can be seen from FIG. 1 the blade or cutting arrangement) which is provided for cutting a band or length of material 15 having a great material thickness 16, is comprised of an upper blade 10 and a lower blade 12, whereby each of the upper blade 10 and lower blade 12 has a sharp blade or cutting edge 11 or 13 respectively. In this connection, upper blade 10 and lower blade 12 are disposed or positioned relative to one another in such a way that an overlap zone 14 of the two cutting edges 11, 13 results. To achieve the best possible cutting result, upper blade 10 and lower blade 12 are positioned in such a way that the center of the overlap zone 14 is disposed in the middle of the material thickness of the length of material 15.

In the embodiment illustrated in FIG. 2, the material that is to be cut or divided by the upper blade 10 and the lower blade 12 is comprised of a stack 18 of individual bands or lengths of material 17 that are disposed one above the other and that together also form a correspondingly great material thickness. The stack 18 is disposed on a fixation or guide table 20 and by means thereof is fed to the blade arrangement 10, 12. The lower blade 12 extends through the fixation table 20 and, by an amount that is to be set in conformity to the respective material thickness of the material that is to be cut and to the to required overlap zone, extends beyond the surface of the fixation table 20 that forms a zero or reference line for the positioning of the lower blade 12. In conformity with the embodiment described in conjunction with FIG. 1, here also the upper blade 10 and lower blade 12 are to be positioned by means of the adjusting or placing mechanisms that support them in such a way that the center of the overlap zone 14 of the cutting edges 11, 13 is disposed in the middle of the overall material thickness of the stack 18.

The features of the subject matter of the these documents disclosed in the preceding specification, the claims and the drawing can be important individually as well as in any desired combination with one another for realizing the various embodiments of the invention.

1-10. (canceled)

11. A cuffing arrangement for longitudinally cutting or dividing material, comprising:
two blades (10, 12) that are disposed across from one another and that during a cutting process cooperate with one another, wherein each of said blades (10, 12) is embodied as a circular blade having a sharp cutting edge (11, 13) and supported by an adjusting or placement mechanism, and wherein during a cutting process said circular blades (10, 12) are positioned by means of said adjusting or placement mechanisms in such a way that said cutting edges (11, 13) overlap one another to form an overlap zone (14) and a center of said overlap zone (14) coincides with a middle of the material that is to be cut or divided.

12. A cutting arrangement according to claim 11, wherein the material is composed of a length of material (15) having a given material thickness, and wherein said circular blades (10, 12) are positioned in such a way that the center of said overlap zone (14) is disposed in the middle of said material thickness of said length of material (15).

13. A cutting arrangement according to claim 11, wherein the material that is to be cut or divided is composed of a stack (18) of individual lengths of material (17), and wherein said circular blades (10, 12) are positioned in such a way that the center of said overlap zone (14) is disposed in the middle of the overall material thickness of said stack (18) of lengths of material (17).

14. A cutting arrangement according to claim 11, wherein respective sensors for detecting or determining said overlap zone (14) are disposed on said adjusting or placement mechanisms for said circular blades (10, 12) and are coupled with control devices for respective adjustment movements of said circular blades (10, 12).

15. A cutting arrangement according to claim 11 and further comprising a fixation device (20) that is adapted to feed the material that is to be cut or divided to said circular blades (10, 12), wherein a lower one of said blades (12) extends beyond an upper edge of said fixation device (20) by an amount that is to be set in conformity with a material thickness of the material that is to be cut or divided and to said overlap zone (14) of said circular blades (10, 12).

16. A cutting arrangement according to claim 15 wherein said fixation device (20) is embodied as a fixation or guide table (20) that is adapted to support the material that is to be cut or divided.

17. A cutting arrangement according to claim 15, wherein said fixation device is embodied as a fixation roller over which the material that is to be cut or divided is adapted to be guided.

18. A cuffing arrangement according to claim 14, wherein said control devices for the adjustment movements of said circular blades (10, 12) are connected to an input unit for the material thickness of the material that is to be cut or divided.

19. A cutting arrangement according to claim 11, and further comprising a device for determining or detecting the material thickness of the material that is to be cut or divided, wherein said device is disposed upstream of said circular blades (10, 12) and is connected to control devices for adjustment movements of said circular blades (10, 12).

20. A cutting arrangement according to claim 19, and further comprising a fixation device (20) for support or feeding of the material that is to be cut or divided to said circular blades (10, 12) and a device for determining or detecting the material thickness of the material that is to be cut or divided, wherein said device is disposed on said fixation device (20).
